(19) United States
(12) Patent Application Publication
(10) Pub. No.: US 2011/0055534 A1
(43) Pub. Date: Mar. 3, 2011

(54) Management Method for Security of Computer Device

(76) Inventor: Chieh-Fu CHUNG, Hsin-Tien (TW)

(21) Appl. No.: 12/547,530

(22) Filed: Aug. 26, 2009

(51) Int. Cl. G06F 9/00

(52) U.S. Cl. 713/2; 713/300

(57) ABSTRACT

A management method is adapted for a computer device. The management method comprises: firstly turning on a power source of the computer device; then performing a power-on verification procedure by a BIOS of the computer device; determining whether passing through a power-on verification according to a result of performing the power-on verification procedure; starting an OS of the computer device if passing through the power-on verification; and crashing the computer device if not passing through the power-on verification.

### BACKGROUND

1. Field of the Invention

The present invention relates to a management method for a computer device, and more particularly to a management method for the security of the computer device.

2. Description of the Related Art

For managing securities of computer devices, conventional computer lock devices are mainly divided into a hardware lock technology and a software lock technology. The hardware lock technology needs additional devices (such as interface cards or smart cards) and corresponding installing processes. Although the hardware lock technology has a high security thereof, the additional devices and installing processes will consume more cost. On the other hand, the software lock technology employs external storage devices (such as USB flash disks) to storage certificates, and the operation system thereof will verify whether the certificates are valid after starting the operation system. Although the software lock technology is convenient in use and the cost thereof is low, but it is easy to be broken. For example, the software lock can be broken by changing power-on disks of the computer devices or entering the safe mode in the Microsoft Windows system.

Therefore, what is needed is providing a management method for a security of a computer, which is convenient in use, has a low cost and provide a high security.

### BRIEF SUMMARY

A management method in accordance with an exemplary embodiment of the present invention is adapted for a computer device. The management method comprises: turning on a power source of the computer device; performing a power-on verification procedure by a BIOS of the computer; determining whether passing through a power-on verification according to a result of performing the power-on verification procedure; starting an OS of the computer device if passing through the power-on verification; and crashing the computer device if not passing through the power-on verification.

In some exemplary embodiment of the present invention, the management method further comprises: performing a monitoring verification procedure after starting the OS; determining whether passing through a monitoring verification according to a result of performing the monitoring verification procedure; persistently turning on the power source of the computer device and performing the monitoring verification procedure again if passing through the monitoring verification; turning off the power source of the computer device, or locking at least one function operation of the computer device and performing the monitoring verification procedure again if not passing through the monitoring verification.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a computer device and performing systems in accordance with an exemplary embodiment of the present invention.

FIG. 2 is a flow chart of a management method in accordance with an exemplary embodiment of the present invention.

FIGS. 3A and 3B are flow charts of performing a power-on verification procedure in accordance with an exemplary embodiment of the present invention.

FIGS. 4A and 4B are flow charts of performing a monitoring verification procedure in accordance with an exemplary embodiment of the present invention.

FIG. 5 is a flow chart of an operation method if not passing through the monitoring verification procedure in accordance with an exemplary embodiment of the present invention.

### DETAILED DESCRIPTION

Reference will now be made to the drawings to describe exemplary embodiments of the present management method for a security of a computer, in detail. The following description is given by way of example, and not limitation.

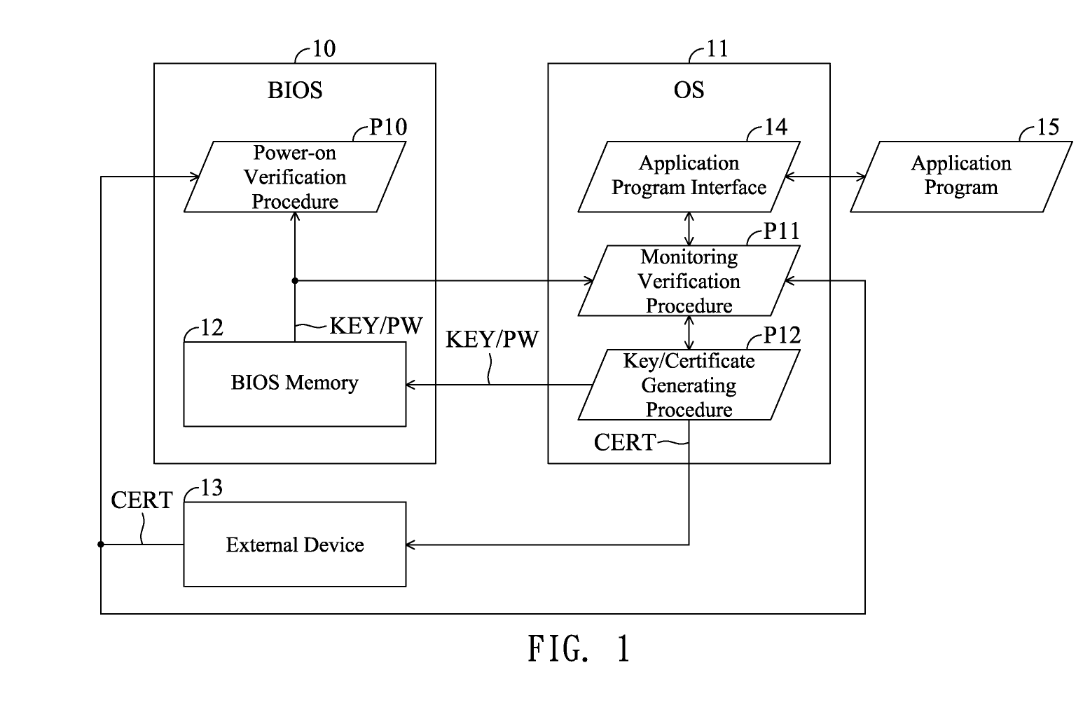

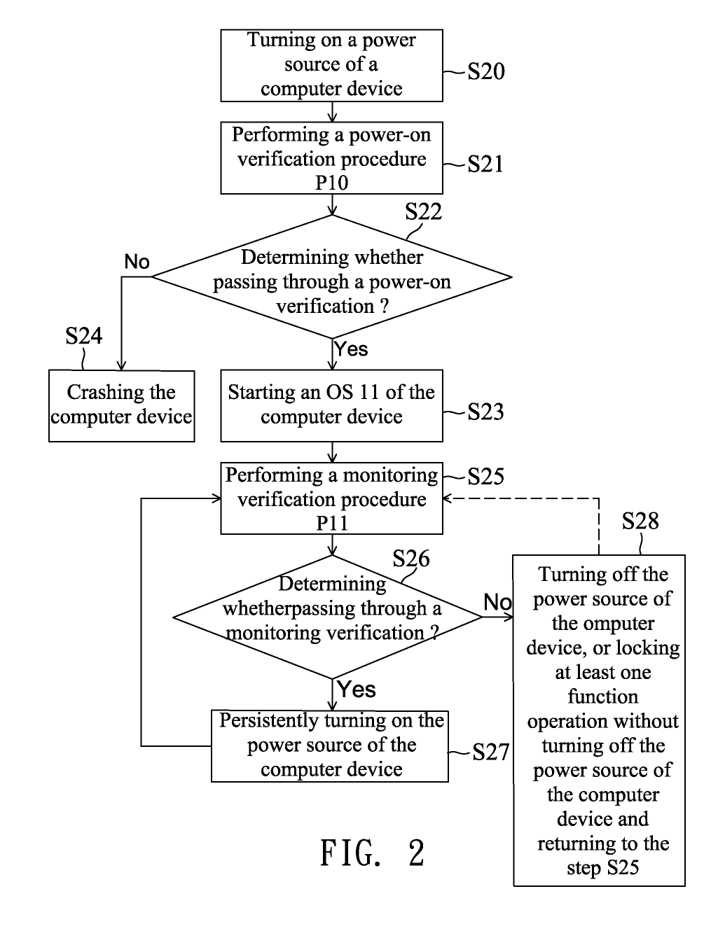

FIG. 1 is a schematic view of a computer device and performing systems in accordance with an exemplary embodiment of the present invention. Referring to FIG. 1, the computer device comprises a basic input/output system (BIOS) 10 and an operation system (OS) 11. FIG. 2 is a flow chart of a management method in accordance with an exemplary embodiment of the present invention. The following will cooperate FIGS. 1 and 2 to describe the management method of the exemplary embodiment of the present invention. Firstly, the BIOS 10 performs a power-on verification procedure P10 (a step S21) after turning on a power source of the computer device (a step S20). Then the BIOS 10 determines whether passing through a power-on verification according to a result of performing the power-on verification procedure P10 (a step S22). If passing through the power-on verification, the OS 11 of the computer device starts (a step S23); and if not passing through the power-on verification, the computer device crashes (a step S24). After starting the OS 11, the OS 11 performs a monitoring verification procedure P11 (a step S25). Then the OS 11 determines whether passing through the monitoring verification according to a result of performing the monitoring verification procedure P11 (a step S26). If passing through the monitoring verification, the power source of the computer device is persistently turned on (a step S27), and the OS 11 performs the monitoring verification procedure P11 again (the step S25). In this exemplary embodiment, the OS 11 can persistently or periodically perform the monitoring verification procedure P11. If not passing through the monitoring verification, the power source of the computer device is turned off, or the OS 11 locks at least one function operation without turning off the power source (a step S28) and the monitoring verification procedure P11 is repeated persistently or periodically (the step S25). In this exemplary embodiment, the function operation of the computer device may comprise a use or a supply of a keyboard a mouse, a power source of a screen, etc. For example, if not passing through the monitoring verification, the use of the keyboard and/or the mouse may be locked, and/or the power source stops supplying to the screen. The function operation of the computer device also comprises specific application programs. For example, if not passing through the monitoring verification, a browser and/or a mail software, etc., are locked.

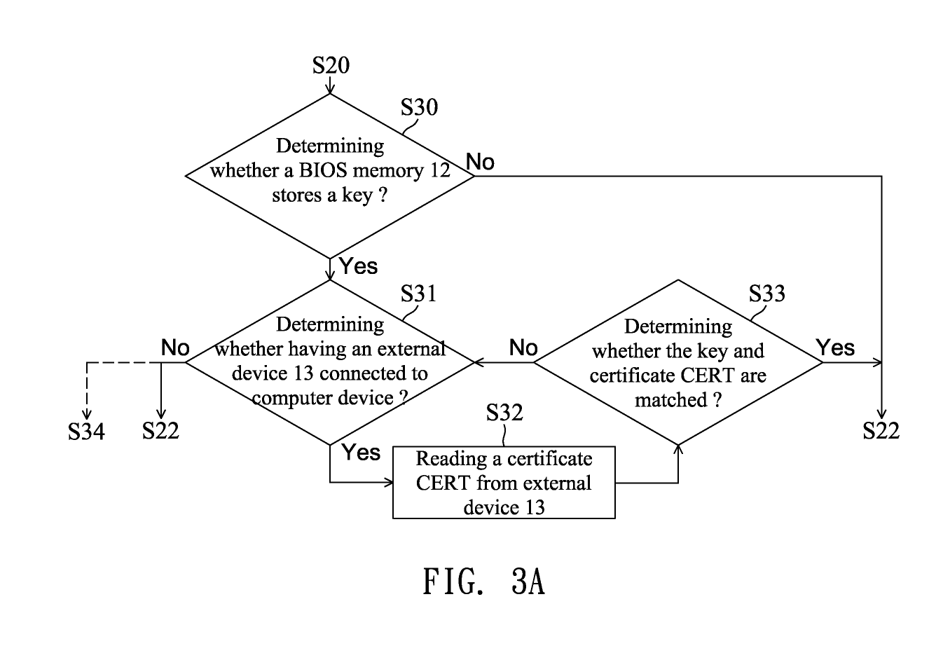

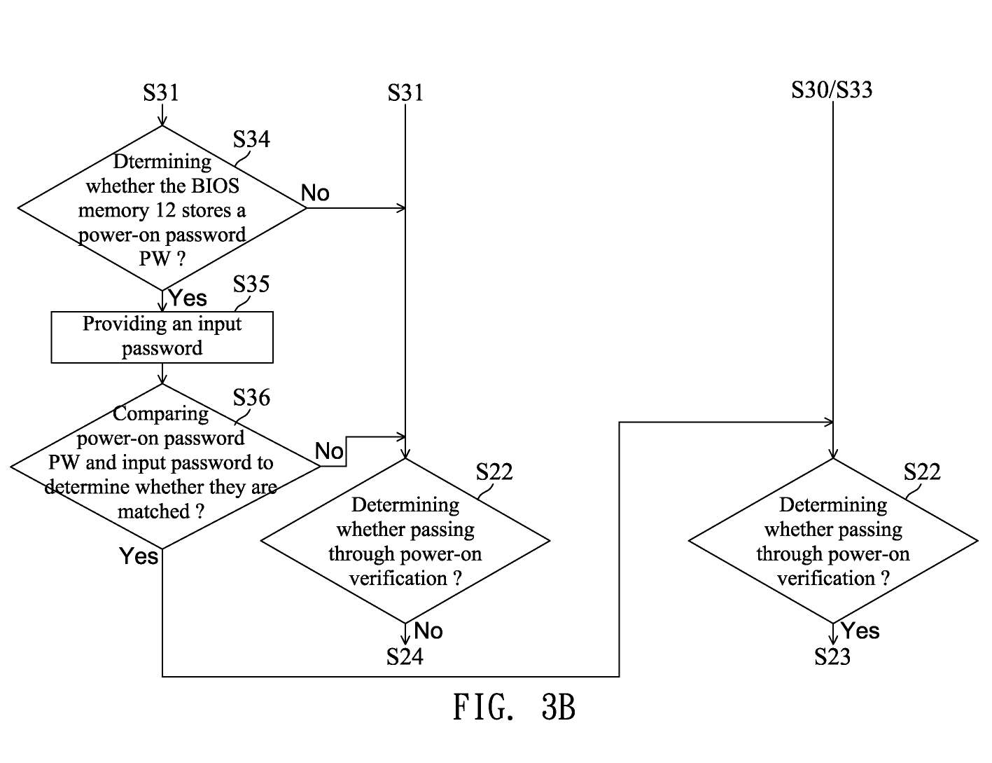

FIGS. 3A and 3B are detailed flow charts of the step S21 of performing the power-on verification procedure P10 as shown in FIG. 2. Referring to FIGS. 1 and 3, after turning on the power source of the computer device, the BIOS 10 determines whether a BIOS memory 12 stores a key (a step S30). In this exemplary embodiment, if the BIOS memory 12 does not store the key, the BIOS 10 determines passing through the power-on verification in the step 22, and then starts the OS 11 of the computer device (the step S23).

If the BIOS memory 12 stores the key, the BIOS 10 then determines whether having an external device 13 connected to the computer device (a step S31). In this exemplary embodiment, the external device 13 may be a USB flash disk configured for storing a certificate CERT. The key stored in the BIOS memory 12 and the certificate stored in the external device 13 are generated by the OS 11 performing a key/certificate generating procedure P12 when the computer device previously starts the OS 11.

A performing result of the step S31 is a basis for determining whether passing through the power-on verification (the step S22). If not having the external device 13 connected to the computer device, the BIOS 12 will determine not passing through the power-on verification in the step S22, and the computer device will crash (the step S24).

If having the external device 13 connected to the computer device, the certificate CERT stored therein is read from the external device 13 (a step S32). After reading the certificate CERT stored in the external device 13, the BIOS 10 compares the key and the certificate CERT to determine whether the key and the certificate CERT are matched (a step S33). A performing result of the step S33 is another basis for determining whether passing through the power-on verification (the step S22) in FIG. 2. If the key is matched with the certificate CERT, the BIOS 10 determines passing through the power-on verification in the step S22, and then starts the OS 11 of the computer device (the step S23). If the key is not matched with the certificate CERT, the step S31 is returned, and the BIOS 10 determines whether having another external device which is connected to the computer device and has not been read the certificate. If having the external device 13 which is connected to the computer device and has not been read, the step S32 and S33 are repeated.

In this exemplary embodiment, if the step S31 determines not having any external device connected to the computer device after performing the step S30, or if the step S31 determines not having the external device which is connected to the computer device and has not been read the certificate after performing the step S33, the BIOS 10 determines not passing through the power-on verification in the step S22, and then the computer device crashes (the step S24).

In another exemplary embodiment, if the step S31 determines not having any external device connected to the computer device, or determines not having the external device which is connected to the computer device and has not been read the certificate, the BIOS 10 may determine whether the BIOS memory 12 stores a power-on password PW (a step S34). A performing result of the step S34 is used as other basis for determining whether passing through the power-on verification (the step S22). If the BIOS memory 12 does not store the power-on password PW, the BIOS 10 determines not passing through the power-on verification procedure P10 in the step S22, and the computer device crashes (the step S24).

If the BIOS memory 12 stores the power-on password PW, it will ask users to provide an input password via an input interface (a step S35). Then the BIOS 10 compares the power-on password PW and the input password to determine whether the two passwords are matched (a step S36). A performing result of the step S36 is used as another basis for determining whether passing through the power-on verification (the step S22). If the power-on password PW and the input password are matched, the BIOS 10 determines passing through the power-on verification in the step S22, and then starts the OS 11 of the computer device (the step S23). If the power-on password PW and the input password are not matched, the BIOS 10 determines not passing through the power-on verification in the step S22 and the computer device crashes (the step S24). In this exemplary embodiment, if the OS 11 starts since the power-on password PW and the input password are matched, the OS 11 will determine the users providing the input password has a low permission and lock at least one function operation of the computer device although the OS 11 starts.

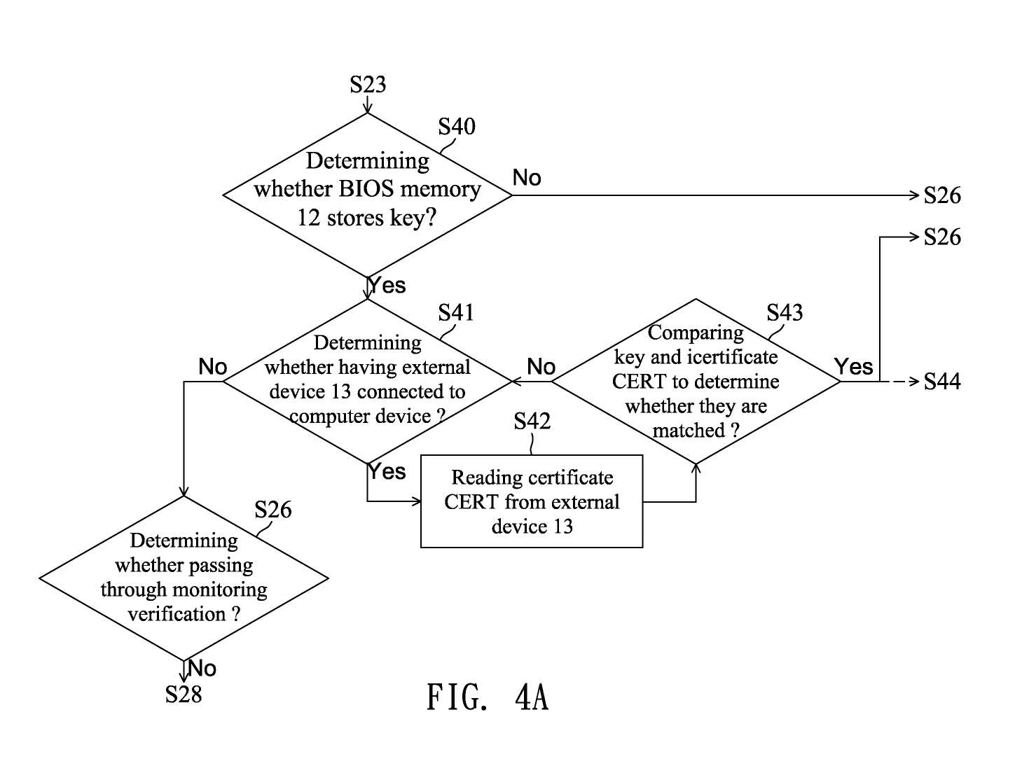

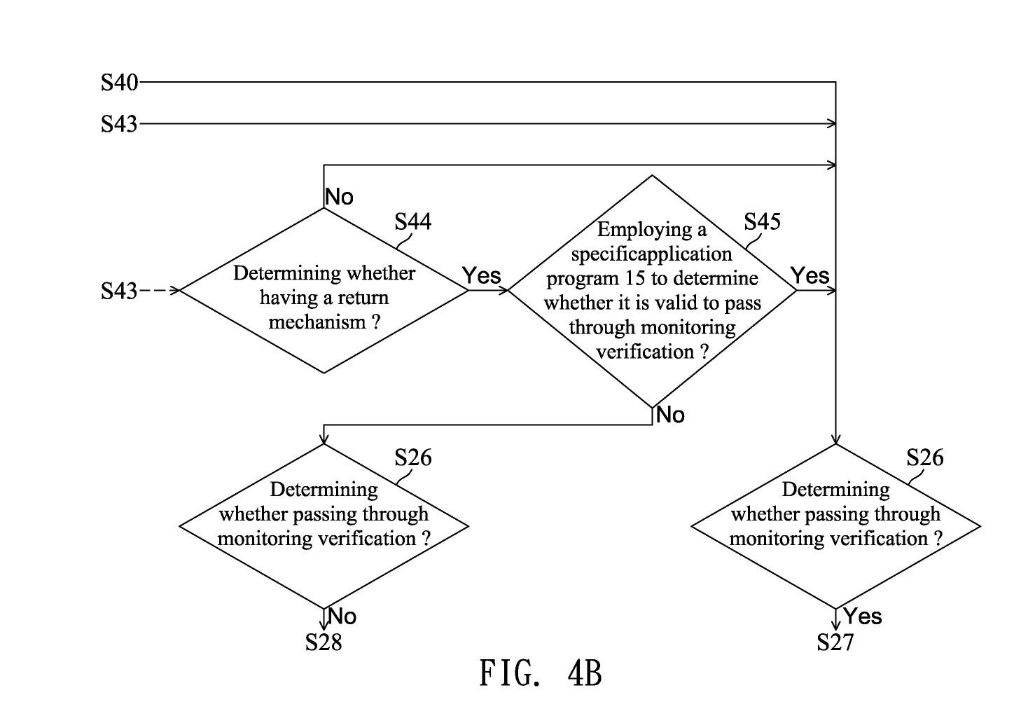

FIG. 4A and 4B are detailed flow charts of the step S25 of performing the monitoring verification procedure P11 as shown in FIG. 2. Referring to FIGS. 1 and 4A-4B, after starting the OS 11, the OS 11 determines whether the BIOS memory 12 stores the key (a step S40). In this exemplary embodiment, in the condition that the step S30 of FIGS. 3A and 3B determines the BIOS memory 12 does not store the key to further start the OS 11, the BIOS 12 does not store the key at this moment. The OS 11 determines passing through the monitoring verification in the step S26, then the power source of the computer device is persistently turned on (the step S27), and the OS 11 performs the monitoring verification procedure P11 again (the step S25).

If the BIOS memory 12 stores the key, the OS 11 determines whether having the external device 13 connected to the computer device (a step S41). A performing result of the step S41 is a basis for determining whether passing through the monitoring verification (the step S26). If not having the external device 13 connected to the computer device, the OS 11 determines not passing through the monitoring verification in the step S26 and turns off the power source of the computer device. Alternatively, the OS 11 does not turn off the power source of the computer device, and locks at least one function operation of the computer device (the step S28) and performs the monitoring verification procedure P11 again (the step S25).

If having the external device 13 connected to the computer device, the certificate CERT stored in the external device 13 are read (a step S42). After reading the certificate CERT stored in the external device 13, the OS 10 compares the key and the certificate CERT to determine whether the key and the certificate CERT are matched (a step S43). A performing result of the step S43 is another basis to determine whether passing through the monitoring verification. If the key and the certificate CERT are matched, the OS 11 determines passing through the monitoring verification in the step S26 and persistently turns on the power source of the computer device (the step S27). Furthermore, the OS 11 performs the monitoring verification procedure P11 again (the step S25). In this exemplary embodiment, when at least one function operation of the computer device has been locked which is described in the above, if determining passing through the monitoring verification, the power source of the computer device is persistently turned on in the step 27 and the locked function operation is unlocked.

If the key and the certificate CERT are not matched, the step S41 is returned. The OS 11 determines whether having an external device which is connected to the computer device and has not been read the certificate thereof. If having the external device which is connected to the computer device and has not been read the certificate thereof, the step S42 and the step S43 are repeated.

In this exemplary embodiment, if the step S41 determines not having any external device connected to the computer device after performing the step S40, or the step S41 determines not having the external device which is connected to the computer device and has not been read the certificate thereof after performing the step S43, the BIOS 10 determines not passing through the monitoring verification in the step S26. Then, the power source of the computer device is turned off. Alternatively, the power source of the computer device is not turned off and the OS 11 locks at least one function operation of the computer device (the step S28) and performs the monitoring verification procedure P11 again (the step S25).

In some exemplary embodiments, some application programs of the OS 11, such as a timing lock program, are performed according to a performing result of whether passing through the monitoring verification. The users may set it is valid passing through the monitoring verification procedure P11 via an application program interface 14 when a time of keeping starting the OS 11 exceeds a predetermined time-length if passing through the monitoring verification. Therefore, when the time of keeping starting the OS 11 exceeds the predetermined time-length, the timing lock program determines overtime, and locks a part of function operations of the computer device.

Referring to FIGS. 1 and 4A-4B, if the step S43 determines the key and the certificate CERT are not matched, the OS 11 determines whether having a return function (a step S44). If not having the return function, the OS 11 determines passing through the monitoring verification in the step S26. Then the power source of the computer device is persistently turned on (the step S27), and the OS performs the monitoring verification procedure P11 again (the step S25).

If having the return function, a specific application program 15 is used to determine whether it is valid to pass through the monitoring verification (a step S45). If it is valid to pass through the monitoring verification, the OS 11 determines passing through the monitoring verification in the step S11. Then the power source of the computer device is persistently turned on (the step S27) and the OS 11 performs the monitoring verification procedure P11 again (the step S25). If it is not valid to pass through the monitoring verification, the OS 11 determines not passing through the monitoring verification in the step S26, and the power source of the computer device is turned off. Alternatively, the power source of the computer device is not turned off, and the OS 11 locks at least one function operation of the computer device (the step S28) and performs the monitoring verification procedure P11 again (the step S25).

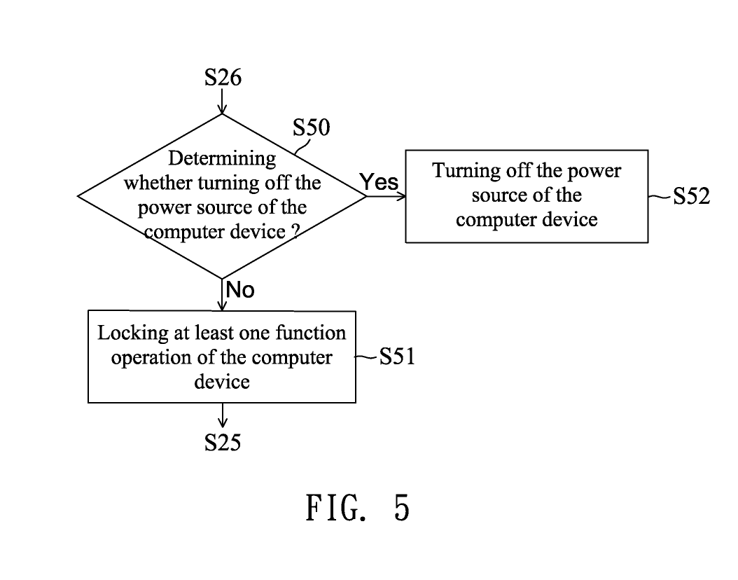

FIG. 5 is a detailed flow chart of the step S28 as shown in FIG. 2. Referring to FIGS. 2 and 5, the OS 11 determines not passing through the monitoring verification in the step S26, and the step S28 enters. Firstly, the OS 11 determines whether turning off the power source of the computer device (a step S50). If not turning off the power source of the computer device, the OS 11 locks at least one function operation of the computer device and performs the monitoring verification procedure P11 again (a step S51). On the contrary, the power source of the computer device is turned off (a step S52).

In this exemplary embodiment, when not passing through the monitoring verification procedure P11, the application program can set to lock any function operation via the application program interface 14.

In summary, after starting the power source of the computer device, firstly, the BIOS 10 performs the power-on verification procedure P10 to manage the security of the computer device. If not passing through the power-on verification procedure P10, the OS 11 can not be started and can not be entered even if changing the power-on disk. In addition, the key is stored in the BIOS memory 12 and is difficult to be filched or altered. Therefore the management method of the exemplary embodiment of the present invention provides a high security of the computer device. In addition, the external device is used to store the certificate CERT, thus the management method is convenient and has a low cost for the users.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A management method adapted into a computer device, comprising:
turning on a power source of the computer device;
performing a power-on verification procedure by a basic input/output system (BIOS) of the computer device;
determining whether passing through a power-on verification according to a result of performing the power-on verification procedure;
starting an operation system (OS) of the computer device if passing through the power-on verification; and
crashing the computer device if not passing through the power-on verification.

2. The management method as claimed in claim 1, wherein the step of performing the power-on verification procedure comprises:
determining whether a BIOS memory of the computer device stores a key;
determining whether having an external device connected to the computer device if the BIOS memory stores the key, wherein the external device stores a certificate;
reading the certificate from the external device if having the external device connected to the computer device; and
comparing the key and the certificate to determine whether the key and the certificate are matched, wherein a performing result of determining whether the key and the certificate are matched, is a basis for determining whether passing through the power-on verification procedure.

3. The management method as claimed in claim 2, wherein the step of determining whether passing through the power-on verification comprises:
determining passing through the power-on verification if the key and the certificate are matched.

4. The management method as claimed in claim 2, wherein the step of performing the power-on verification procedure further comprises:
determining whether having another external device connected to the computer device if the key and the certificate, wherein the another external device stores another certificate;
reading the another certificate from the another external device if having the another external device connected to the computer device; and
comparing the key and the another certificate to determine whether the key and the another certificate are matched.

5. The management method as claimed in claim 4, wherein the step of determining whether passing through the power-on verification comprises:
determining not passing through the power-on verification if not having the another external device connected to the computer device.

6. The management method as claimed in claim 2, wherein the step of determining whether passing through the power-on verification comprises:
determining not passing through the power-on verification if not having the external device connected to the computer device.

7. The management method as claimed in claim 2, wherein the step of performing the power-on verification procedure further comprises:
determining whether the BIOS memory stores a power-on password if not having the external device connected to the computer device;
providing an input password if having the power-on password; and
comparing the power-on password and the input password to determine whether the power-on password and the input password are matched.

8. The management method as claimed in claim 7, wherein the step of determining whether passing through the power-on verification comprises:
determining passing through the power-on verification if the power-on password and the input password are matched; and
determining not passing through the power-on verification if the power-on password and the input password are not matched.

9. The management method as claimed in claim 7, wherein the step of determining whether passing through the power-on verification comprises:
determining not passing through the power-on verification if not having the power-on password.

10. The management method as claimed in claim 1, further comprising:
performing a monitoring verification procedure after starting the OS;
determining whether passing through a monitoring verification according to a performing result of the monitoring verification procedure;
persistently turning on the power source of the computer device and performing the monitoring verification procedure again if passing through the monitoring verification procedure; and
turning off the power source of the computer device or locking at least one function operation of the computer device and performing the monitoring verification procedure again if not passing through the monitoring verification.

11. The management method as claimed in claim 10, wherein the step of turning off the power source of the computer device or locking the at least one function operation of the computer device comprises:
determining whether turning off the power source of the computer device; and
locking the at least one function operation and performing the monitoring verification procedure again if not turning off the power source of the computer device.

12. The management method as claimed in claim 10, wherein the step of performing the monitoring verification procedure comprises:
determining whether a memory of the computer device stores a key;
determining whether having an external device connected to the computer device if the memory stores the key, wherein the external device stores a certificate;
reading the certificate from the external device if having the external device connected to the computer device; and
comparing the key and the certificate to determine whether the key and the certificate are matched.

13. The management method as claimed in claim 12, wherein the step of determining whether passing through the monitoring verification comprises:
determining passing through the power-on verification if the key and the certificate are matched.

14. The management method as claimed in claim 12, wherein the step of performing the monitoring verification procedure comprises:
determining whether having another external device connected to the computer device if the key and the certificate are not matched, wherein the another external device stores another certificate;
reading the another certificate from the another external device if having the another external device connected to the computer device; and
comparing the key and the another certificate to determine whether the key and the another certificate are matched.

15. The management method as claimed in claim 14, wherein the step of determining whether passing through the monitoring verification comprises:
determining not passing through the monitoring verification if not having the another external device connected to the computer device.

16. The management method as claimed in claim 12, wherein the step of determining whether passing through the monitoring verification comprises:
determining not passing through the monitoring verification if not having the external device connected to the computer device.

17. The management method as claimed in claim 10, wherein the step of persistently turning on the power source of the computer device further comprises:
When the at least one function operation of the computer device has been locked in the above, unlocking the at least one locked function operation if passing through the monitoring verification.

18. The management method as claimed in claim 10, wherein the step of performing the monitoring verification procedure further comprises:
determining whether having a return mechanism if passing through the monitoring verification;
employing an application program to determine whether it is valid to pass through the monitoring verification if having the return mechanism, wherein if the application program determine it is valid to pass through the monitoring verification, the step of determining whether passing through the monitoring verification determines passing through the monitoring verification, and if the application program determines it is invalid, the step of determining whether passing through the monitoring verification determines not passing through the monitoring verification; and
determining passing through the monitoring verification in the step of determining whether passing through the monitoring verification if not having the return mechanism.
